(19) United States
(12) Patent Application Publication
(10) Pub. No.: US 2009/0067903 A1
(43) Pub. Date: Mar. 12, 2009

(54) COIL UNIT FOR INDUCTION HEATING FIXING DEVICE

(75) Inventors: Shuji Yokoyama, Shizuoka (JP); Masanori Takai, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/206,628

(22) Filed: Sep. 8, 2008

Related U.S. Application Data
(60) Provisional application No. 60/971,250, filed on Sep. 10, 2007.

(51) Int. Cl. G03G 15/20

(52) U.S. Cl. 399/330

(57) ABSTRACT

In an embodiment of the present invention, an electromagnetic induction coil, insulating plates, and a magnetic core are positioned by a coil holder including holder plates on which ribs are integrally formed. Consequently, the electromagnetic induction coil is regulated from sliding on the holder plates and fixed in a desired proper position regardless of flows of a mold material caused when a coil mold is injection-molded.

### CROSS-REFERENCE TO RELATED APPLICATION

This application is based upon and claims the benefit of priority from U.S. Provisional Application Ser. No. 60/971,250 filed on Sep. 10, 2007, the entire contents of which are incorporated herein by reference.

### TECHNICAL FIELD

The present invention relates to a coil unit for an induction heating fixing device that inductively heats a conductive heat generating member of a heating member for a fixing device mounted on an image forming apparatus such as a copying machine, a printer, or a facsimile.

### BACKGROUND

As a fixing device of a heating and pressing type used in image forming apparatuses such as a copying machine and a printer of an electrophotographic system, there is a fixing device that heats a heat roller or a heating belt having a metal conducive layer in an induction heating system. This induction heating fixing device has high responsiveness to a temperature change in the heat roller or the like. Therefore, the induction heating fixing device can immediately raise the temperature of the heat roller or the like and can realize an increase in process speed including a reduction in warming-up time. The induction heating system is a system for feeding a high-frequency current to a coil to generate an electromagnetic wave, feeding an induction current generated by the electromagnetic wave to, for example, a metal conductive layer of a heat roller, and causing the metal conductive layer to generate heat with Joule heat generated by the induction current.

However, when a metal conductive layer having a small heat capacity is used, a heat generation characteristic of the metal conductive layer is substantially affected by a magnetic characteristic of the coil. On the other hand, when electric power is supplied to the coil, vibration is caused in the coil by the high-frequency current flowing to the coil. When the coil vibrates, a positional relation between the coil and the metal conductive layer changes and the magnetic characteristic of the coil changes. Consequently, it is likely that the heat generation characteristic of the metal conductive layer changes and fixing performance is spoiled.

Therefore, conventionally, there is a coil unit in which a bobbin that supports a coil and a magnetic core is set in a die for injection molding and insulative resin is injected into a space of the die to seal the bobbin, the coil, and the magnetic core and prevent vibration of the coil.

However, in the coil unit, it is likely that the coil is affected by a flow of the insulative resin injected into the space in the die and moves. Therefore, the coil cannot be encapsulated in a proper position. This causes a fall in yield during manufacturing of the coil unit.

Therefore, there is a demand for a coil unit for heating a metal conductive layer in an induction heating system, wherein, when a coil is sealed by resin and fixed in order to stabilize a heat generation characteristic of the metal conductive layer, movement of the coil by a flow of the resin is regulated and a coil position is held in a proper position to realize improvement of manufacturing yield.

### SUMMARY

According to an aspect of the present invention, there is provided a coil unit for an induction heating fixing device in which, when a coil is sealed by insulative resin in order to prevent vibration of the coil, the coil is prevented from moving from a proper position to realize high manufacturing yield.

According to an embodiment of the present invention, the coil unit for an induction heating fixing device includes a coil, a magnetic core arranged with a predetermined space from the coil, a positioning holder that supports the coil and the magnetic core, a fixing member that is hardened after being molded in a liquid state and fixes the coil and the magnetic core, which are supported by the positioning holder, together with the positioning holder, and a movement regulating member that regulates the coil from being moved along the positioning holder by the pressing force of the liquid-state fixing member.

### DESCRIPTION OF THE DRAWINGS

FIG. 1 is a schematic structural diagram showing an image forming apparatus mounted with a fixing device in which a coil unit according to a first embodiment of the present invention is used;

FIG. 2 is a schematic structural diagram showing the fixing device according to the first embodiment of the present invention;

FIG. 3 is a schematic explanatory diagram showing an arrangement of a heat roller and the coil unit according to the first embodiment of the present invention;

FIG. 4 is a disassembled perspective view of the coil unit according to the first embodiment of the present invention;

FIG. 5 is a disassembled side view of the coil unit according to the first embodiment of the present invention;

FIG. 6 is a schematic side view showing a state in which an electromagnetic induction coil, an insulating plate, and a magnetic core are positioned by a coil holder according to the first embodiment of the present invention;

FIG. 7 is a schematic front view showing a die according to the first embodiment of the present invention;

FIG. 8 is a schematic explanatory diagram showing the coil unit according to the first embodiment of the present invention; and

FIG. 9 is a schematic explanatory diagram showing a coil unit according to a second embodiment of the present invention.

### DETAILED DESCRIPTION

A first embodiment of the present invention is explained in detail below with reference to the accompanying drawings.

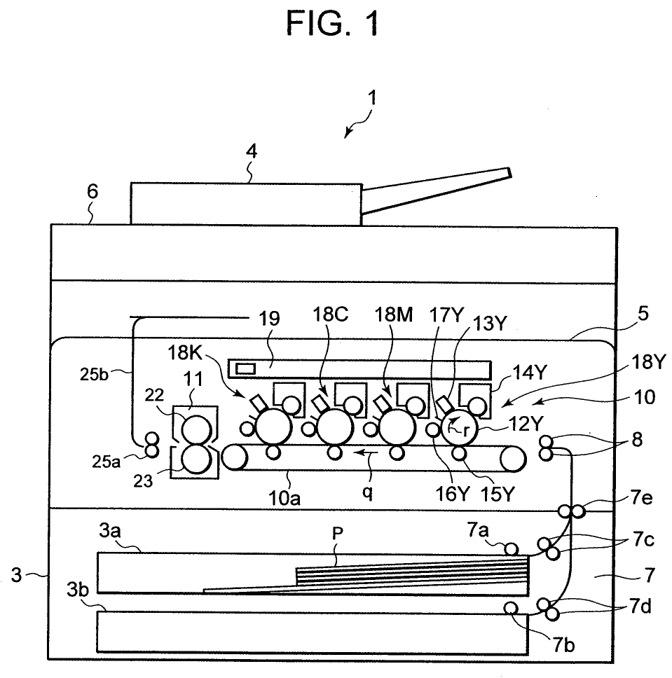

FIG. 1 is a schematic structural diagram showing a color copying machine 1 of a four-tandem system mounted with a fixing device 11, which is an induction heating fixing device, according to the first embodiment of the present invention. The color copying machine 1 includes, in an upper part thereof, a scanner unit 6 that scans an original supplied by an automatic document feeder 4. The color copying machine 1 includes an image forming unit 10 including four image forming stations 18Y, 18M, 18C, and 18K for yellow (Y), magenta (M), cyan (C), and black (K) arranged in parallel along a transfer belt 10a.

In the image forming station 18Y for yellow (Y), a charging device 13Y, a developing device 14Y, a transfer roller 15Y, a cleaner 16Y and a charge removing device 17Y as process members are arranged around a photoconductive drum 12Y as an image carrier that rotates in an arrow r direction. A laser exposing device 19 that irradiates a laser beam on the photoconductive drum 12Y is provided above the image forming station 18Y for yellow (Y).

The image forming stations 18M, 18C, and 18K for the respective colors of magenta (M), cyan (C), and black (K) have the same configuration as the image forming station 18Y.

In the image forming unit 10, according to the start of print operation, in the image forming station 18Y for yellow (Y), the photoconductive drum 12Y rotates in the arrow r direction to be uniformly charged by the charging device 13Y. Subsequently, exposure light corresponding to image information scanned by the scanner unit 6 is irradiated on the photoconductive drum 12Y by the laser exposing device 19 and an electrostatic latent image is formed thereon. Thereafter, a toner image is formed on the photoconductive drum 12Y by the developing device 14Y. In the position of the transfer roller 15Y, the toner image is transferred onto sheet paper P, which is an image fixing medium, carried in an arrow q direction on the transfer belt 10a. After the transfer is finished, a residual toner on the photoconductive drum 12Y is cleaned by the cleaner 16. Charges on the surface of the photoconductive drum 12Y are removed by the charge removing device 17Y. In this way, the photoconductive drum 12Y is prepared for the next print.

The sheet paper P is fed from a cassette mechanism 3 including first and second paper feeding cassettes 3a and 3b to the transfer belt 10a through a carrying path 7. The carrying path 7 includes pickup rollers 7a and 7b that take out the sheet paper from the paper feeding cassettes 3a and 3b, separating and carrying rollers 7c and 7d, carrying rollers 7e, and registration rollers 8. The fixing device 11 that fixes a toner image formed on the sheet paper P by the image forming unit 10 is provided downstream of the transfer belt 10a. Paper discharge rollers 25a and a paper discharging and carrying path 25b for carrying the sheet paper P after fixing to a paper discharge unit 1b are provided downstream of the fixing device 11.

The image forming stations 18M, 18C, and 18K for the respective colors of magenta (M), cyan (C), and black (K) perform image forming operation in the same manner as the image forming station 18Y for yellow (Y) and form a full color toner image on the sheet paper P carried by the transfer belt 10a. Thereafter, the sheet paper P is heated and pressed by the fixing device 11, which is the induction heating fixing device, to have the full color toner image fixed thereon. After a print image is completed, the sheet paper P is discharged to the paper discharge unit lb.

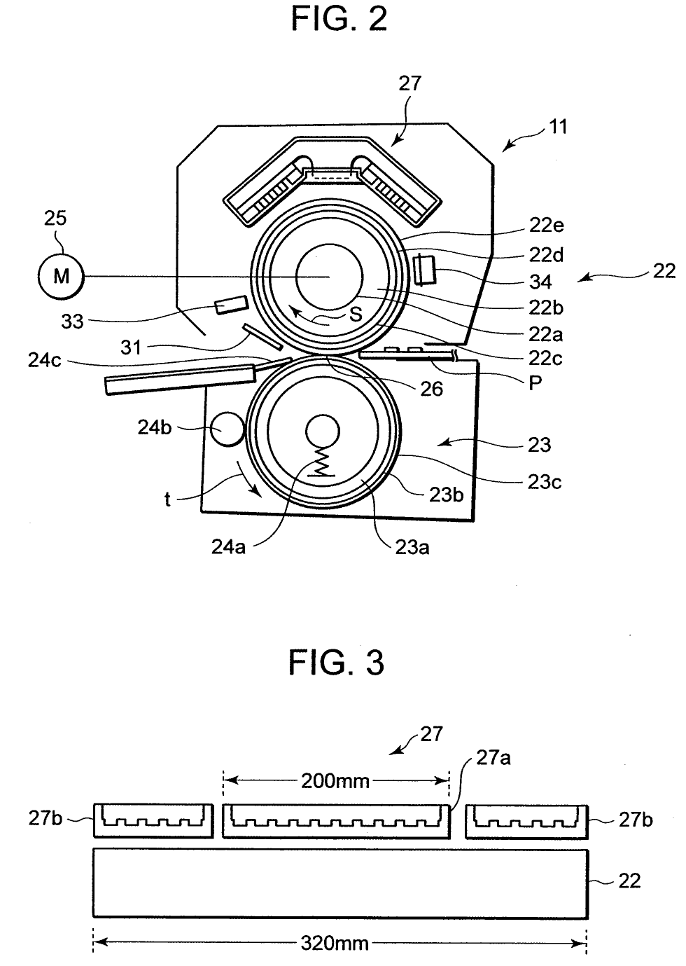

The fixing device 11 is described. FIG. 2 is a schematic structural diagram showing the fixing device 11 of the induction heating system. The fixing device 11 includes a heat roller 22 as a heating member and a press roller 23 as a carrying member. The heat roller 22 is rotated in an arrow s direction by a driving motor 25. The press roller 23 is pressed and brought into contact with the heat roller 22 by a pressing spring 24a. Consequently, a nip 26 with fixed width is formed between the heat roller 22 and the press roller 23. The press roller 23 rotates in an arrow t direction following the heat roller 22.

A coil unit 27 as an induction current generating coil that causes the heat roller 22 to generate heat is arranged to be opposed to the heat roller 22 via a gap of, for example, 2.5 mm. The gap between the coil unit 27 and the heat roller 22 is not limited. However, to satisfactorily cause the heat roller 22 to generate heat, it is preferable to set the gap in a range of 1.5 mm to 5.0 mm.

Moreover, in an outer circumference of the heat roller 22, a peeling pawl 31 that prevents twining of the sheet paper P after fixing, a non-contact thermistor 33 that detects the surface temperature of the heat roller 22, and a thermostat 34 for sensing abnormality of the surface temperature of the heat roller 22 and interrupting the heat generation are provided. A press-side peeling pawl 24c and a cleaning roller 24b are provided in an outer circumference of the press roller 23.

When it is unlikely that the sheet paper P twines around the heat roller 22, the peeling pawl 31, the press-side peeling pawl 24c, and the like do not have to be provided. The number of non-contact thermistors 33 is arbitrary according to necessity. A necessary number of non-contact thermistors 33 can be arranged in necessary places in a longitudinal direction of the heat roller 22, which is a rotating shaft direction of the heat roller 22.

In the heat roller 22, around a shaft 22a formed of a material having rigidity (hardness) that is not deformed by predetermined pressure, an elastic layer 22b made of an elastic material such as foamed rubber or sponge, a metal conductive layer 22c made of a conductive material as a conductive heat generating member, a solid rubber layer 22d made of heat resistant silicone rubber or the like, and a release layer 22e are formed in order. The metal conductive layer 22c is formed of a conductive material made of nickel (Ni), stainless steel, aluminum (Al), copper (Cu), a composite material of stainless steel and aluminum, or the like. In this embodiment, the metal conductive layer 22c is formed of nickel (Ni).

It is preferable that, in the heat roller 22, for example, the elastic layer 22b is formed in the thickness of 5 mm to 10 mm, the metal conductive layer 22c is formed in the thickness of 10 μm to 100 μm, and the solid rubber layer 22d is formed in the thickness of 100 μm to 200 μm. In this embodiment, the elastic layer 22b is formed in the thickness of 5 mm, the metal conductive layer 22c is formed in the thickness of 40 μm, the solid rubber layer 22d is formed in the thickness of 200 μm, and the release layer 22e is formed in the thickness of 30 μm.

The press roller 23 includes a core bar 23a and a rubber layer 23b of silicone rubber, fluorine rubber, or the like around the core bar 23a. The rubber layer 23b is coated with a release layer 23c. Both the heat roller 22 and the press roller 23 are formed with a diameter of, for example, 40 mm. The sheet paper P passes through the nip 26 between the heat roller 22 and the press roller 23, whereby the toner image on the sheet paper P is heated, pressed, and fixed thereon.

The press roller 23 has, when necessary, a metal conductive layer that is caused to generate heat by the electromagnetic induction coil. Alternatively, the press roller 23 may have a heating mechanism such as a halogen lamp heater incorporated therein.

The coil unit 27 is described. As shown in FIG. 3, the coil unit 27 includes a center coil unit 27a and side coil units 27b on both sides of the center coil unit 27a. In this embodiment, the two side coil units 27b are connected in series and driven by the same control. For example, the center coil unit 27a has the length of 200 mm and causes the center area of the heat roller 22 to generate heat. The side coil units 27b are arranged on both the sides of the center coil unit 27a. The entire length 320 mm of the heat roller 22 is caused to generate heat by the center coil unit 27a and the side coil units 27b. Outputs of the center coil unit 27a and the side coil units 27b may be alternately switched or may be simultaneous.

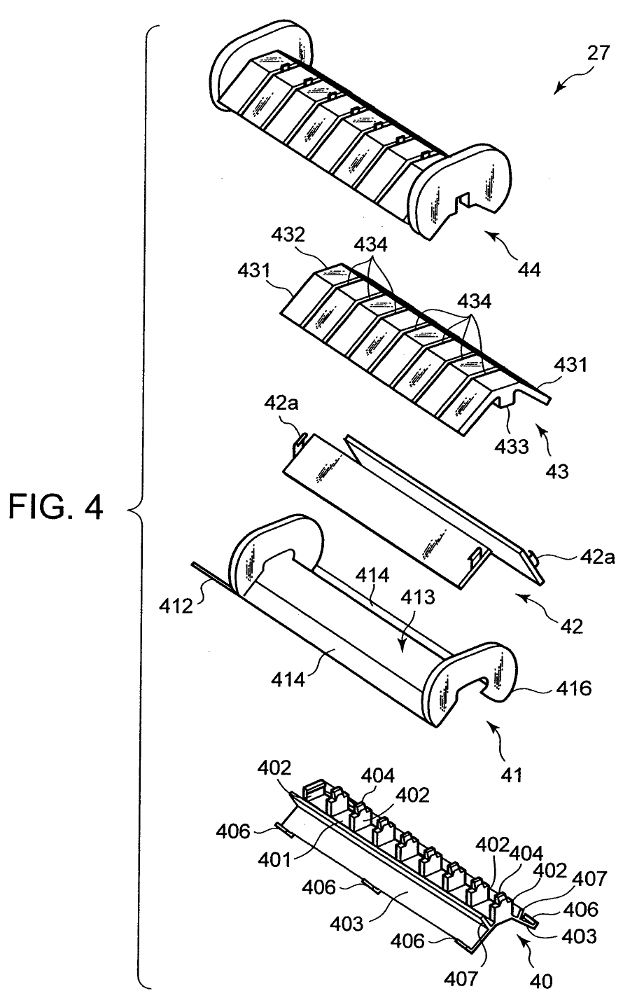

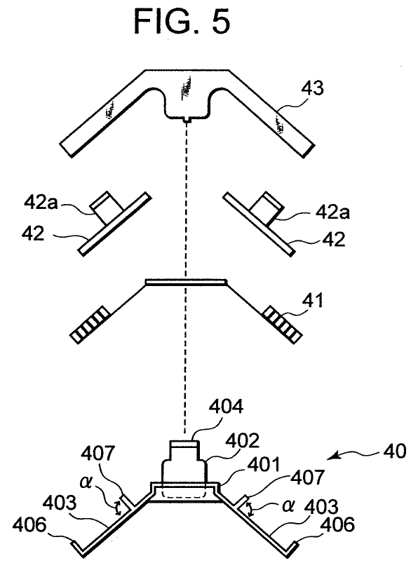

The center coil unit 27a and the side coil units 27b have different lengths but have the same structure. Therefore, the center coil unit 27a and the side coil units 27b having the same structure are explained below as a common coil unit 27. As shown in FIGS. 4 and 5, the coil unit 27 has a coil holder 40 as a positioning holder, a wire-wound electromagnetic induction coil 41 as a coil, insulating plates 42 as insulators, a magnetic core 43, and a coil mold 44 as a fixing member.

As the electromagnetic induction coil 41, a Litz wire as a conductive wire formed by, for example, binding plural copper wires having a diameter of about 0.1 mm to 0.5 mm, on a surface of which heat resistant enamel coating of, for example, heat resistant polyamideimide is applied, is used. Wires and insulating materials are not limited to the above and a wire diameter is arbitrary. When the Litz wire is used, the structure thereof is also arbitrary, and may be formed by twisting plural insulated copper wires. The number and the thickness of the copper wires are not limited. By using the Litz wire, it is possible to feed an electric current using respective copper wire surfaces forming the Litz wire. Therefore, it is possible to efficiently use an electric current flowing to the electromagnetic induction coil 41.

The electromagnetic induction coil 41 is a wire-wound coil formed by winding one Litz wire 412 around an arbitrary slender molding block when the electromagnetic induction coil 41 formed. When the electromagnetic induction coil 41 is removed from the molding block after the electromagnetic induction coil 41 is formed, a slender coil hole 413 is formed in a molding block portion thereof. Coil centers 414 of the electromagnetic induction coil 41 are wound in parallel to a longitudinal direction of the coil hole 413. Coil ends 416 of the electromagnetic induction coil 41 parallel to a latitudinal direction of the coil hole 413 are wound to be raised in the vertical direction with respect to the coil centers 414 and are formed in a fan shape.

The electromagnetic induction coil 41 generates a magnetic flux when a high-frequency current is applied thereto. An eddy current as an induction current is generated in the metal conductive layer 22c of the heat roller 22 by this magnetic flux to prevent a change in a magnetic field. Joule heat is generated by this eddy current and the resistance of the metal conductive layer 22c. The heat roller 22 is heated by the Joule heat.

The insulating plates 42 are molded by using, for example, PPS resin (Poly Phenylene Sulfide) having the molding temperature (hardening temperature) of about 280° C. The insulating plates 42 have a flat shape for covering the coil centers 414 of the electromagnetic induction coil 41 and are molded in the thickness of, for example, about 1.0 mm. The insulating plates 42 have hook sections 42a for fixing the insulating plates 42 to the magnetic core 43 in positioning the same. A material and a shape of the insulating plates 42 are not limited. The material does not have to be the PPS resin as long as the electromagnetic induction coil 41 and the magnetic core 43 can be surely insulated in the coil unit 27. The molding temperature of the insulating plates 42 is arbitrary. The thickness of the insulating plates 42 is also arbitrary. However, the thickness is more preferably in a range of 0.5 mm to 1.5 mm to secure insulating properties and prevent magnetic efficiency of the magnetic core 43 from being spoiled.

It is possible to manage an induction current flowing to the metal conductive layer 22c of the heat roller 22 by changing the thickness of the insulating plates 42 to adjust a distance between the electromagnetic induction coil 41 and the magnetic core 43. In other words, it is possible to adjust a generated heat distribution of the metal conductive layer 22c by managing the thickness of the insulating plates 42. For example, if the insulating plates 42 are reduced in thickness in the same coil unit, a heating value of the metal conductive layer 22c can be increased. On the other hand, if the insulating plates 42 are increased in thickness, the heating value of the metal conductive layer 22c can be reduced.

The magnetic core 43 concentrates magnetic fluxes of the electromagnetic induction coil 41 on the heat roller 22 and improves a magnetic characteristic of the electromagnetic induction coil 41. Therefore, a section of the magnetic core 43 is generally formed in a roof shape having core inclined sections 431 inclined to both sides along the coil centers 414 of the electromagnetic induction coil 41. A core flat section 432 in the center of the magnetic core 43 has a core projected section 433 for positioning supported by the coil holder 40.

The coil holder 40 is made of a material same as that of the insulating plates 42 and is molded by using PPS resin having the molding temperature of about 280° C. The coil holder 40 has a holder main body 401 formed slender according to the shape of the coil hole 413 of the electromagnetic induction coil 41, plural holder bosses 402 provided at predetermined intervals in the holder main body 401, and holder plates 403 that extend downward from the holder main body 401.

At ends of the holder plates 403 attached to the holder main body 401, ribs 407 as movement regulating members are molded integrally with the holder plates 403. The ribs 407 regulate the movement of the electromagnetic induction coil 41 such that the electromagnetic induction coil 41 is arranged in a desired proper position when the coil unit 27 is completed. The desired proper position of the electromagnetic induction coil 41 is arbitrary according to a type of a coil unit.

As a setting angle of the ribs 407 formed on the holder plates 403, as shown in FIG. 5, an interior angle α on a side coming into contact with the electromagnetic induction coil 41 is, for example, 90° with respect to the surface of the holder plates 403. The setting angle of the ribs 407 on the holder plate 403 is not limited to 90°. The setting angle may be any angle as long as, when a mold material is filled by using a die described later, the electromagnetic induction coil 41 can be prevented from shifting from the desired proper position or riding over the holder bosses 402 sides. For this purpose, as the setting angle of the ribs 407 on the holder plates 403, the interior angle α on the side coming into contact with the electromagnetic induction coil 41 is preferably equal to or smaller than 90°.

The plural holder bosses 402 of the coil holder 40 prevent the electromagnetic induction coil 41 from moving in a longitudinal direction. Moreover, pawl members 404 at upper ends of the holder bosses 402 are fit in slits 434 provided in the core flat section 432 in the center of the magnetic core 43 to regulate a position of the magnetic core 43. The holder plates 403 incline along the inclination of the coil centers 414 of the electromagnetic induction coil 41. As shown in FIG. 5, the holder plates 403 support the coil centers 414 of the electromagnetic induction coil 41 from below. Hooks 406 formed at distal ends of the holder plates 403 support outer sides of the coil centers 414 of the electromagnetic induction coil 41.

The coil holder 40 positions the electromagnetic induction coil 41 and the magnetic core 43 with the insulating plates 42 interposed between the electromagnetic induction coil 41 and the magnetic core 43. The electromagnetic induction coil 41 and the magnetic core 43 are surely insulated by the insulating plates 42.

The coil mold 44 is formed by injecting a liquid-state insulative mold material (resin material) and, then, hardening and molding the same. As the mold material, for example, PPS resin having the molding temperature (hardening temperature) of about 320° C. is used. The mold material is not limited to this. The mold material may be, for example, phenolic resin, resin containing glass, carbon, or ceramic. The mold material is preferably resin having heat resistance that is not thermally deformed by thermal convection caused by the heat roller 22.

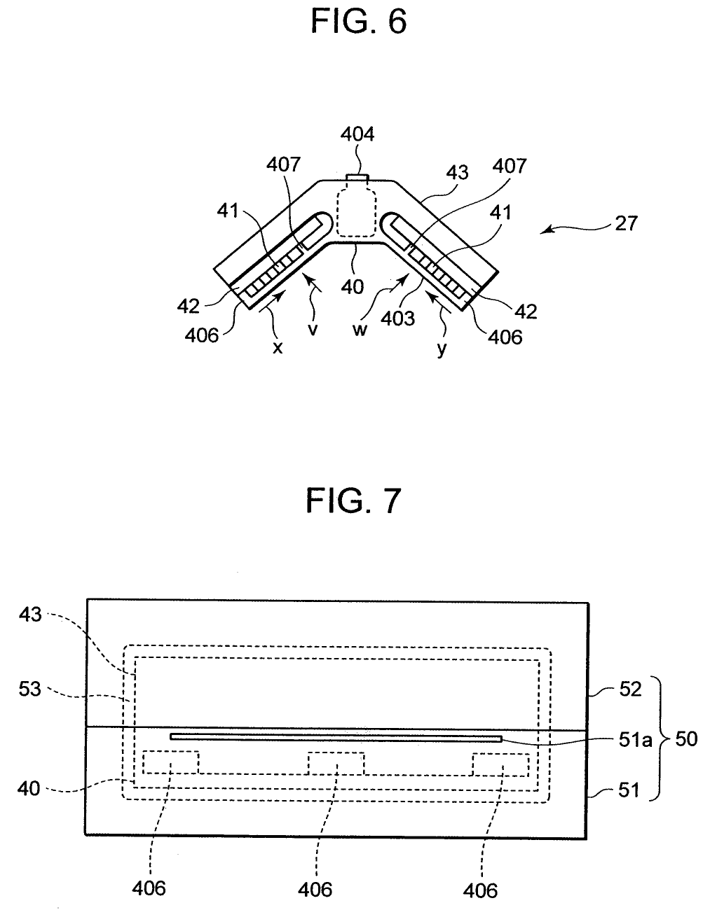

Injection molding of the coil mold 44 is described. As shown in FIG. 6, the electromagnetic induction coil 41, the insulating plates 42, and the magnetic core 43 are positioned (preliminarily fixed) by the coil holder 40. For the positioning, the plural holder bosses 402 of the coil holder 40 are inserted into the coil hole 413 of the electromagnetic induction coil 41. Subsequently, the insulating plates 42 are arranged on the coil centers 414 of the electromagnetic induction coil 41. The holder bosses 402 of the coil holder 40 and the core projected section 433 of the magnetic core 43 are engaged with each other from above and below the insulating plates 42 to preliminarily fix the magnetic core 43 to the coil holder 40. The pawl members 404 of the coil holder 40 are fit in the slits 434 of the magnetic core 43. Consequently, the electromagnetic induction coil 41, the insulating plate 43, and the magnetic core 43 are positioned by the coil holder 40.

Thereafter, as shown in FIG. 7, the coil holder 40 including the electromagnetic induction coil 41, the insulating plates 42, and the magnetic core 43 are set in a die 50 in order to injection-mold the coil mold 44. The die 50 is formed by coupling a first die 51 and a second die 52. After the coil holder 40 is fixed and supported in the first die 51, the second die 52 is coupled (clamped) to the first die 51. Then, a space 53 equivalent to a shape of the coil mold 44 is formed around the coil holder 40 including the electromagnetic induction coil 41, the insulating plates 42, and the magnetic core 43 in the die 50. A film gate 51a opened in a slit shape is formed in the first die 51 as an injection port for filling a liquid-state mold material. The film gate 51a is formed to be substantially parallel to the longitudinal direction of both sides of the coil holder 40.

The coil holder 40 including the electromagnetic induction coil 41, the insulating plates 42, and the magnetic core 43 is set in the die 50 and the liquid-state mold material is injected from the film gate 51a of the first die 51. Then, the mold material is filled in the space 53. At this point, the mold material causes flows for pushing the electromagnetic induction coil 41 on both sides of the coil holder 40 in an arrow x direction and an arrow y direction. The electromagnetic induction coil 41 on both sides is slid by the flows in the arrow x direction and the arrow y direction along the holder plates 403 of the coil holder 40. However, when the electromagnetic induction coil 41 comes into contact with the ribs 407 formed on the holder plates 403, the electromagnetic induction coil 41 is regulated from sliding and stops while being in contact with the ribs 407. Therefore, when the mold material is filled, it is unlikely that the electromagnetic induction coil 41 deviates from the proper position. As a result, production of defective articles can be prevented.

When the mold material is filled in the space 53, the mold material causes flows for pushing the coil holder 40 in an arrow v direction and an arrow w direction. The electromagnetic induction coil 41 may be shifted closer to the magnetic core 43 side by the flows. However, since the insulating plates 42 are interposed between the electromagnetic induction coil 41 and the magnetic core 43, it is unlikely that the electromagnetic induction coil 41 and the magnetic core 43 come into contact with each other.

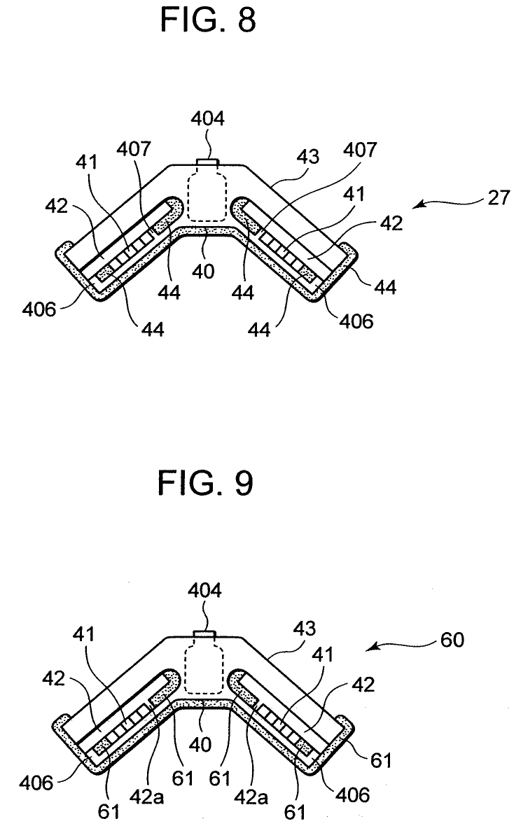

When the mold material is filled, contact portions of the coil holder 40 and the insulating plates 42 having the molding temperature of about 280° C. with the mold material having the molding temperature of about 320° C. are softened by the heat of the mold material. Consequently, the mold material better adheres to the coil holder 40 and the insulating plates 42. When the mold material is cooled to the temperature equal to or lower than 320° C., the coil mold 44 is integrally molded with the insulating plates 42 and the coil holder 40 and hardened. Consequently, as shown in FIG. 8, the coil unit 27 in which the electromagnetic induction coil 41 regulated by the ribs 407 and the magnetic core 43 are sealed by the coil mold 44 is formed.

The center coil unit 27a and the side coil units 27b molded in this way are used in the fixing device 11 to supply high-frequency power to the electromagnetic induction coil 41 for heat generation of the heat roller 22. Then, since the electromagnetic induction coil 41 is fixed in the proper position by the coil mold 44, vibration of the electromagnetic induction coil 41 is prevented. Therefore, a positional relation between the electromagnetic induction coil 41 and the metal conductive layer 22c of the heat roller 22 is maintained constant. Constant heat generation temperature is obtained over the entire length of the heat roller 22.

According to the first embodiment, when the coil mold 44 is injection-molded in order to fix the electromagnetic induction coil 41 with the mold material, the coil holder 40 in which the ribs 407 are provided on the holder plates 403 is used to position the electromagnetic induction coil 41, the insulating plates 42, and the magnetic core 43. Consequently, even if the electromagnetic induction coil 41 is slid along the holder plates 403 by the flows of the liquid-state mold material filled in the die 50, the electromagnetic induction coil 41 is fixed while being stopped in the desired proper position by the ribs 407. Therefore, defective articles of the coil unit 27 due to the movement of the electromagnetic induction coil 41 by the flows of the mold material are not produced. As a result, manufacturing yield of the coil unit 27 can be improved.

A second embodiment of the present invention is explained. The second embodiment is different from the first embodiment in arrangement positions of the movement regulating members. Otherwise, the second embodiment is the same as the first embodiment. Therefore, components same as those explained in the first embodiment are denoted by the same reference numerals and signs and detailed explanation of the components is omitted.

As shown in FIG. 9, in a coil unit 60 according to the second embodiment, ribs 42a as movement regulating members are formed integrally with the insulating plates 42 for insulating the electromagnetic induction coil 41 and the magnetic core 43. Therefore, it is unnecessary to provide ribs on the coil holder 40 side. The ribs 42a on the insulating plates 42 only have to regulate the movement of the electromagnetic induction coil 41 such that the electromagnetic induction coil 41 is arranged in a desired proper position when the coil unit 60 is completed. Therefore, as a setting angle of the ribs 42a on the insulating plates 42, an interior angle on a side coming into contact with the electromagnetic induction coil 41 is preferably equal to or smaller than 90°. The desired proper position of the electromagnetic induction coil 41 is arbitrary according to a type of a coil unit.

When a coil mold 61 for fixing the electromagnetic induction coil 41 in the coil unit 60 is injection-molded, the electromagnetic induction coil 41, the insulating plates 42 having the ribs 42a, and the magnetic core 43 are positioned by the coil holder 40. The coil holder 40 is fixed in the die 50. Subsequently, the mold material is injected from the film gate 51a and filled in the space 53.

At this point, the electromagnetic induction coil 41 is moved by flows of the mold material. However, the electromagnetic induction coil 41 is regulated from moving by the ribs 42a formed on the insulating plates 42 and stops while being in contact with the ribs 42a. Therefore, when the mold material is filled, it is unlikely that the electromagnetic induction coil 41 deviates from the proper position. As a result, production of defective articles can be prevented.

According to this embodiment, as in the first embodiment, when the coil mold 61 is injection-molded, the electromagnetic induction coil 41 can be fixed in the desired proper position. Therefore, defective articles of the coil unit 60 due to the movement of the electromagnetic induction coil 41 by the flows of the mold material are not produced. As a result, manufacturing yield of the coil unit 60 can be improved.

The present invention is not limited to the embodiments described above. Various modifications are possible within the scope of the present invention. For example, the endless heating member may be a fixing belt and shapes and the like of the coil and the magnetic core are arbitrary. The structure of the positioning holder is not limited as long as the coil and the magnetic core can be positioned. A material, a shape, the structure, and the like of the movement regulating members are also arbitrary. Movement regulating members formed separately from the positioning holder or the insulators may be, for example, attached to the positioning holder or the insulators. A position, a shape, and a size of the injection port for the mold material of the die are not limited either. A pin-shaped injection port may be provided in an upper part of the second die to inject the mold material. However, as described in the embodiment, if the mold material is injected by using the film gate formed in the slit shape, it is possible to further smooth the flows of the mold material in the die.

What is claimed is:

1. A coil unit for an induction heating fixing device, comprising:
a coil;
a magnetic core arranged with a predetermined space from the coil;
a positioning holder that supports the coil and the magnetic core;
a fixing member that is hardened after being molded in a liquid state and fixes the coil and the magnetic core, which are supported by the positioning holder, together with the positioning holder; and
a movement regulating member that regulates the coil from being moved along the positioning holder by pressing force of the liquid-state fixing member.

2. The unit according to claim 1, wherein the movement regulating member is a regulating rib provided on the positioning holder.

3. The unit according to claim 2, wherein, as a setting angle of the regulating rib on the positioning holder, an interior angle on the coil side is equal to or smaller than 90°.

4. The unit according to claim 1, wherein the coil is regulated on one side by the movement regulating member and regulated on the other side by the fixing member when the coil is fixed by the fixing member.

5. The unit according to claim 1, further comprising an insulator inserted into the predetermined space between the coil and the magnetic core, wherein
the movement regulating member is a regulating rib provided on the insulator.

6. The unit according to claim 5, wherein, as a setting angle of the regulating rib on the insulator, an interior angle on the coil side is equal to or smaller than 90°.

7. An induction heating fixing device comprising:
a heating member having a conductive heat generating member of an endless shape;
a coil unit that is arranged on an outer circumference of the heating member and includes a coil, a magnetic core arranged with a predetermined space from the coil, a positioning holder that supports the coil and the magnetic core, a fixing member that is hardened after being molded in a liquid state and fixes the coil and the magnetic core, which are supported by the positioning holder, together with the positioning holder, and a movement regulating member that regulates the coil from being moved along the positioning holder by pressing force of the liquid-state fixing member; and
a carrying member that nips and carries an image fixing medium in a predetermined direction together with the heating member.

8. The device according to claim 7, wherein the movement regulating member is a regulating rib provided on the positioning holder.

9. The device according to claim 8, wherein, as a setting angle of the regulating rib on the positioning holder, an interior angle on the coil side is equal to or smaller than 90°.

10. The device according to claim 7, wherein the coil is regulated on one side by the movement regulating member and regulated on the other side by the fixing member when the coil is fixed by the fixing member.

11. The device according to claim 7, wherein
the coil unit further includes an insulator inserted into the predetermined space between the coil and the magnetic core, and
the movement regulating member is a regulating rib provided in the insulator.

12. The device according to claim 11, wherein, as a setting angle of the regulating rib on the insulator, an interior angle on the coil side is equal to or smaller than 90°.

13. A method of manufacturing a coil unit, comprising:
regulating a coil not to move a predetermined distance or more along a positioning holder and attaching the coil and a magnetic core to a positioning holder with a predetermined space provided between the coil and the magnetic core;
setting the positioning holder, which supports the coil and the magnetic core, in a die;
injecting a mold material into a space in the die; and
hardening the mold material.

14. The method according to claim 13, wherein the mold material is injected into the space in the die from a film gate of the die.

15. The method according to claim 13, wherein the film gate of the die is provided in a position opposed to both sides in a longitudinal direction of the positioning holder set in the die.

16. The method according to claim 13, wherein, after nipping an insulator in the space between the coil and the magnetic core, attaching the coil and the magnetic core to the positioning holder.
